(19) United States
(12) Patent Application Publication
(10) Pub. No.: US 2015/0310434 A1
(43) Pub. Date: Oct. 29, 2015

(54) SYSTEMS AND METHODS FOR IMPLEMENTING AUTHENTICATION BASED ON LOCATION HISTORY

(71) Applicant: Dennis Takchi Cheung, San Jose, CA (US)

(72) Inventor: Dennis Takchi Cheung, San Jose, CA (US)

(21) Appl. No.: 14/265,085

(22) Filed: Apr. 29, 2014

(51) Int. Cl. G06Q 20/40; G06Q 20/08; H04L 29/06

(52) U.S. Cl. CPC G06Q 20/40; H04L 63/08; G06Q 20/085

(57) ABSTRACT

A system and/or method may be provided to authenticate a user based on the user's location history. In particular, the user's past locations and movements may be detected at the user's mobile device. Information with regard to the user's movements and location may be collected and analyzed to determine certain routines, such as locations frequently visited or routes frequently taken. When a payment request is made from the user's mobile device, the mobile device's recent location history may be compared with the routines of the user. A confidence score may be generated based on the user's recent location history. The confidence score may be used to authenticate the user for the payment request. In an embodiment, the confidence score may be used to determine the transaction fee for using a certain funding source, such as a credit card.

### BACKGROUND

1. Field of the Invention

The present invention generally relates to systems and methods for implementing authentication based on location history.

2. Related Art

In today's commerce, many payment transactions, such as retail purchases, fund transactions, and the like, are made electronically using a payment service provider. Because many transactions, such as online payments, are not made in person, it becomes more difficult for merchants or payment service providers to authenticate users who are making payments. For example, when making a purchase online, a user may use a credit card to pay for the purchase. The payment service provider may categorize the online payment using a credit card as a “card not present” transaction. Merchants typically are charged with a higher transaction. fee for “card not present” transactions, because the payment service provider has to bear a higher fraud risk in “card not present” transactions. Therefore, there is a need for a system or method that helps authenticate users in electronic transactions.

### BRIEF DESCRIPTION OF THE FIGURES

FIG. 1 is block diagram of a networked system suitable for implementing user authentication based on location history according to an embodiment.

FIG. 2 is a flowchart showing a process for collecting location history according to one embodiment.

FIG. 3 is a flowchart showing a process for user authentication based on location history according to one embodiment.

FIG. 4 is a block diagram of a computer system suitable for implementing one or more components in FIG. 1 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to an embodiment, a system and/or method may be provided to authenticate a user based on the user's location history. In particular, the user's past locations and movements may be detected via the Global Positioning System (GPS) at the user's mobile device. Information with regard to the user's movements and location may be collected and analyzed to determine certain routines, such as locations frequently visited or routes frequently taken. When a payment request is made from the user's mobile device, the mobile device's recent location history may be compared with the routines of the user. A confidence score may be generated based on the user's recent location history. For example, a higher confidence score may be generated if the mobile device's recent location history substantially matches the routines of the user's location history. The confidence score may be used to authenticate the user who uses the mobile device to make a payment.

In an embodiment, the confidence score may be used to determine the transaction fee for using a certain funding source, such as a credit card. In another embodiment, the confidence score may be used to determine security levels at the user's mobile device. In still another embodiment, the location history of the user may be used to verify a transaction made. In yet another embodiment, the location history of the crowd may be used to predict traffic patterns and anticipate transportation needs at various locations.

The confidence score may be determined by comparing a recent location history, such as the user device's actual locations and movements during the last 4 hours, with the user's routines, such as where the user typically is during the those 4 hours on other days, such as the preceding seven (or other number) days, the same day of the week (e.g., Saturday) over the last five (or other number) weeks, etc. The user's routines may include locations visited and routes taken by the user at different time schedules. The user's locations and movements may be monitored and analyzed to determine the user's routines. A higher confidence score may be determined if the recent location history of the user device closely matches the typical routines of the user. A higher confidence score may indicate a greater probability that the user is the person using the user device to make a transaction.

In an embodiment, a confidence score required for user authentication may vary based on the level of security requirements for different transactions. For example, a banking transaction may require higher security than a small payment transaction at a convenience store. In an embodiment, the user may determine the confidence level required for different categories of transactions. In some embodiments, the system may use a predetermined period of time as the recent history based on the security requirements. For example, for a higher security transaction, a longer recent location history, such as the last day, may be used to match with the user's routines. For a lower security transaction, a shorter recent location history, such as the last 4 hours, may be used to match with the user's routines. In another embodiment, the recent location history may be the locations and movements of the user device since the last authentication.

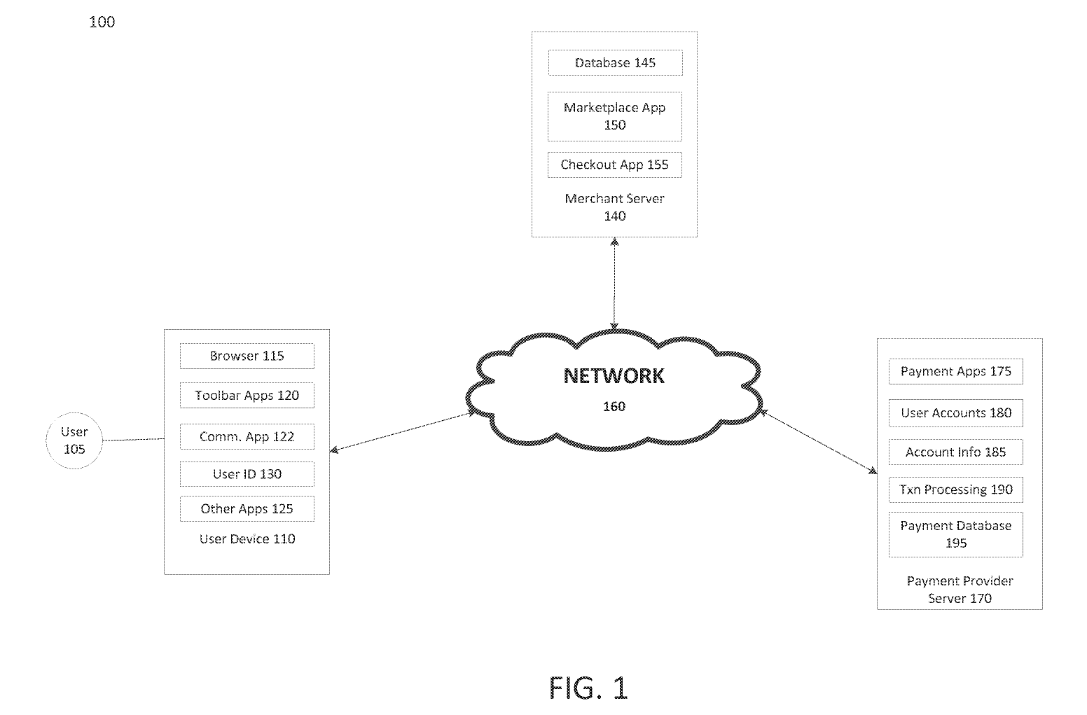

FIG. 1 is a block diagram of a networked system 100 configured to implement a process for notifications of incentives offered by funding sources in accordance with an embodiment of the invention. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

System 100 may include a user device 110, a merchant server 140, and a payment provider server 170 in communication over a network 160. Payment provider server 170 may be maintained by a payment service provider, such as PayPal, Inc. of San Jose, Calif. A user 105, such as a consumer, may utilize user device 110 to perform an electronic transaction using payment provider server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants.

User device 110, merchant server 140, and payment provider server 170 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160.

Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, wearable device, laptop computer, and/or other types of computing devices capable of transmitting and/or receiving data, such as an iPhone™ or iPad™. from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks-in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a smart wallet through the payment provider as discussed above.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the payment provider. A communications application 122, with associated interfaces, enables user device 110 to communicate within system 100.

User device 110 may include applications for collecting location data, such as geo-location data via Global Positioning System (GPS), temperature data, altitude data, humidity data, data regarding device movement, ambient sound data, imaging data via a camera, and etc. Further, geo-fencing or wireless beacon technology may be used to define a location. User device 110 may detect signals from devices that implement geo-fencing or wireless beacon technology. These environmental data may be utilized to determine a location or environment in which user device 110 is located.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be a donation to charity. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through payment provider server 170 over network 160. For example, checkout application 155 may receive and process a payment confirmation from payment provider server 170, as well as transmit transaction information to the payment provider and receive information from the payment provider (e.g., a transaction ID). Checkout application 155 may be configured to receive payment via a plurality of payment methods including cash, credit cards, debit cards, checks, money orders, or the like.

Payment provider server 170 may be maintained, for example, by an online payment service provider which may provide payment between user 105 and the operator of merchant server 140. In this regard, payment provider server 170 may include one or more payment applications 175 which may be configured to interact with user device 110 and/or merchant server 140 over network 160 to facilitate the purchase of goods or services, communicate/display information, and send payments by user 105 of user device 110.

Payment provider server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, user names, phone numbers, credit card information, bank information, or other financial information which may be used to facilitate online transactions by user 105. Advantageously, payment application 175 may be configured to interact with merchant server 140 on behalf of user 105 during a transaction with checkout application 155 to track and manage purchases made by users and which and when funding sources are used.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In one embodiment, payment provider server 170 may receive information related to the location and movements of user 105 detected at user device 110. Payment provider server 170 may log the locations and movements of user 105 and may store the information related to user 105's locations and movements in a location history database. The location history of user 105 may be analyzed to determine user 105's routines. These routines may be used for user authentication. The location history database may continuously be updated to determine the most recent routines of user 105. The location history database may store location history and routines of a plurality of users each associated with a respective user account.

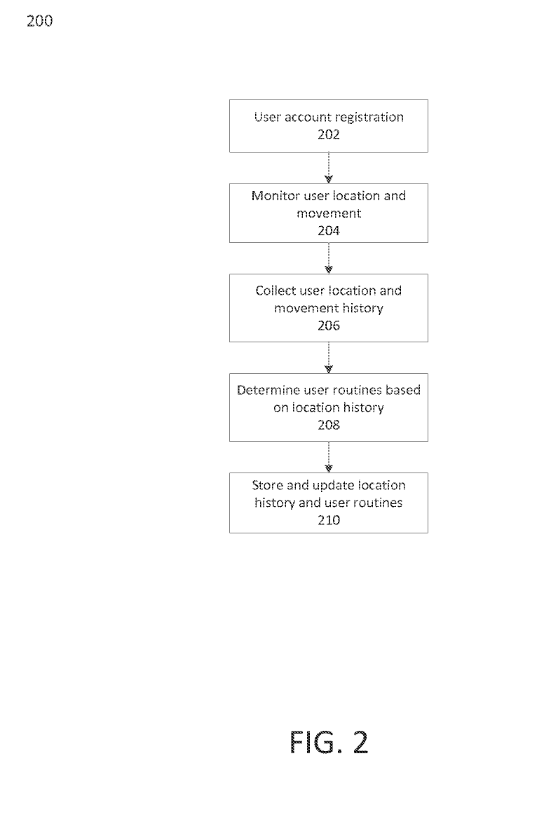

FIG. 2 is a flowchart showing a process 200 for collecting location history according to one embodiment. At step 202, payment provider server 170 may receive user 105's account registration. In particular, user 105 may set up a payment account at the payment service provider to make and receive payments. Further, user 105 may designate one or more funding sources, such as credit cards, debit cards, bank accounts, gift cards, and the like, that may be used to fund the payment account or to make payments. Different funding sources may charge different transaction fees. For example, a credit card operator may charge a higher transaction fee for “card-not-present” transactions as compared to “card-present” transactions. During account registration, payment provider server 170 may inquire user 105 whether user 105 would allow payment provider server 170 to track user 105's location and movements and to authenticate user 105 based on user 105's location history.

Step 202 may be skipped if the user already has an account with the payment service provider. In that case, the payment service provider may access the user's account initially (or at some other point) so that the user's locations and movements can be associated with the user's account.

At step 204, payment provider server 170 may monitor user 105's locations and movements. In particular, the user 105's locations may be detected at user device 110 via GPS or other positioning techniques. The user 105's detected locations may be forwarded from user device 110 to payment provider server 170. At step 206, payment provider server 170 may collect user 105's location and/or movement history. For example, a location history database may be set up at payment provider server 170 to collect the location history of respective users.

At step 208, payment provider server 170 may determine user 105's routines based on user 105's location history. In particular, payment provider server 170 may analyze user 105's location history to identify locations visited repeatedly or routes taken repeatedly by user 105. These repeated locations or routes may be identified as possible routines of user 105. Further, the time and/or date of these repeated locations or routes visited or taken by user 105 may be noted to determine a routine schedule, including the amount of time user 105 typically spends at each location. For example, user 105 may take the same route to work and home every day from Monday through Friday. The locations of user 105's home and work place may both be routine locations. Further, the route between user 105's home and work place may be a routine route.

In particular, the payment service provider 170 may determine that user 105 typically travels from home to work between 7:00 AM and 8:00 AM on week days, that user 105 is typically at work during business hours on week days, and that user 105 typically travels from work to home between 5:00 PM and 6:00 PM on week day. Further, payment service provider 170 may determine that user 105 travels to a lunch place between 12:00 PM and 1:00 PM on week days. On Saturdays, user 105 may typically start at the user's home, walk to a local coffee shop, and then drive to a soccer field and stay there for approximately two hours. This “routine” may only happen on Saturdays over a certain time of year (e.g., during youth soccer leagues). Thus, routines may be specific to days of the week, times of the year, or other pattern.

In an embodiment, a probability may be determined for each of user 105's routine location or route at specific time based on user 105's location history. For example, payment service provider 170 may determine that there is a 93% probability that user 105 is at the work place at 10:00 AM on Monday. Thus, the probability may indicate how likely user 105 is at a certain location or is traveling to a certain location at certain time. A higher probability may indicate a stronger routine while a lower probability may indicate a weaker routine.

In an embodiment, user 105's calendar may be used to determine user 105's routines. In particular, based on user 105's appointments and schedules, user 105's routines may be determined. For example, based on user 105's calendar, user 105 may have a routine of having a lunch meeting on every Friday at a certain restaurant. In another embodiment, location check-ins on user 105's social network accounts may be used to determine user 105's routines. For example, based on user 105's social network status, user 105 may have a routine of checking into a coffee shop every morning on week days to buy a cup of coffee.

In an embodiment, the system may allow user 105 to designate certain routines. For example, user 105 may designate the work place as a routine location during business hours. The system may monitor user 105's actual location and movement to confirm whether user 105's designated routines are correct. For example, the system may monitor user 105's actual location and movement to confirm whether user 105 is actually at the work place during business hours and may determine a probability for the user's designated routine, e.g., 85% probability that user 105 is at the work place during business hours. In another embodiment, the system may determine certain routines based on user 105's location history and may ask user 105 to confirm such routines.

In an embodiment, the system may allow user 105 to designate how routines are determined. For example, the system may allow user 105 to choose a period of time, e.g., the last two year, in which the location history is used to determine routines. Further, the system may allow user 105 to choose the number of repetitions that may constitute a routine. For example, user 105 may designate that a location may become a routine location if user 105 visited the location more than five times. In still another embodiment, the system may allow user 105 to prevent certain locations or routes from becoming routine locations or routes. For example, user105 may prevent home from becoming a routine location to preserve privacy.

In an embodiment, multiple routines with different probabilities may be designated for the same period of time. For example, between 7:00 AM and 8:00 AM on a week day, there is a 65% probability that user 105 is traveling from home to work, a 20% probability that user 105 is buying coffee at a coffee shop near work, a 10% probability that user 105 is at work, and a 5% probability that user 105 is at home. Thus, multiple possible routines with different probabilities may be determined for the same period of time.

At step 210, payment provider server 170 may store and update location history and routines of user 105 in a location history database. The location history database may be updated continuously by logging user 105's recent locations and movements. User 105's routines may continue to be learned and updated by payment provider server 170. Thus, user 105's new or changing routines may be reflected in the location history database. The information of user 105's location history and routines may be encrypted to provide additional security.

By using the above process 200, user 105's locations and movements may be monitored and stored as location history in a location history database. User 105's location history may be analyzed to determined user 105's routines. The location history database may continuously be updated to reflect the most recent location and movement of user 105 to determine user 105's most recent routines. Further, the system may allow user 105 to set and change various settings for collecting user 105's location history and determining user 105's routines.

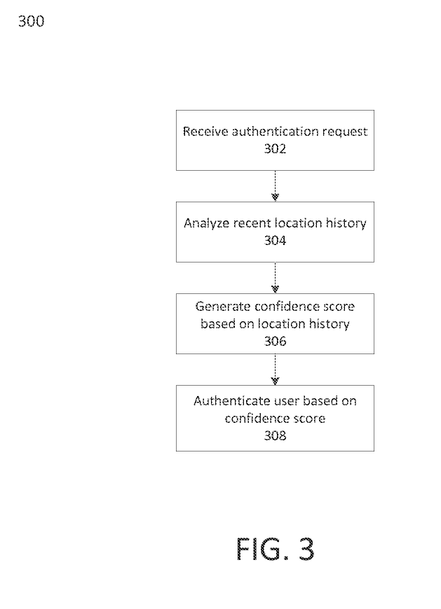

FIG. 3 is a flowchart showing a process for user authentication based on location history according to one embodiment. At step 302, payment provider server 170 may receive an authentication request, such as a payment request. For example, when user 105 is attempting to make a purchase payment using user device 110, user device 110 may send a payment request to payment provider server 170. Payment provider server 170 may attempt to authenticate user 105 or determine whether the payment request can be approved. Other authentication requests, such as user 105 attempting to log into user device 110, online access to user's various financial accounts, social accounts, email accounts, financial transactions, requesting a payment authorization, and the like, also may utilize the location-based authentication process.

At step 304, payment provider server 170 may analyze recent location history of user device 110. In particular, payment provider server 170 may extract a recent location history of a certain length for analysis. In an embodiment, the length of recent location history may be determined based on the security level required for the authentication. For example, a longer location history, such as location history of the past two days, may be used for authentication that requires higher security, such as transferring fund from a bank account, as compared to authentication that required lower security, such as logging into a social network account.

In an embodiment, the recent location history used for authentication may be a period of location history that occurred before the current time or just before the authentication is received, such as the past 8 hours. In another embodiment, the recent location history used for authentication may be a period of location history since the last authentication. For example, the location history used for authentication may be the location history since last time user 105 was authenticated for making a payment using a credit card about 2 days ago.

At step 306, payment provider server 170 may generate a confidence score by analyzing the recent location history of user device 110. In particular, payment provider server 170 may compare user device 110's recent location history with user 105's routines during the same period of time. A confidence score may be determined to indicate how well user device 110's recent location history matches user 105's routines during the same period of time. For example, payment provider server 170 may compare user device 110's locations or movement for the past eight (8) hours with user 105's routines that are supposed to occur for the past eight (8) hours.

In an embodiment, the locations visited by user device 110 in the recent location history may be compared with user 105's routine locations. For example, user 105's routine locations for the last 8 hours may be home, grocery store, and work. User device 110's recent location history for the last 8 hours may be analyzed to determine whether these three routine locations were visited by user device 110 in the last 8 hours. A higher confidence score may be calculated for more matching locations between user 105's routine locations and user device 110's recent location history.

In another embodiment, the routes taken by user device 110 in the recent location history may be compared with user 105's routine routes for the same period of time. For example, user 105's routine routes for the last 8 hours may include a first typical route from home to the grocery store and a second typical route from grocery store to work. User 105 may have a particular manner of travel from one destination to another as based on user 105's habits. For example, user 105 may use a particular mode of traveling, e.g., by bus, by train, by car, by bicycle, on foot, or the etc. The system may analyze user device 110's recent location history for the last 8 hours to determine whether user 105 has taken similar routes from home to the grocery store and from the grocery store to work.

In an embodiment, other manners of traveling, such as the manner of acceleration, the manner of braking, typical speed of travel versus the speed limit, turns made, particular routes taken, and the like, may be considered for determining confidence score. For example, the routines of user 105 may include how user 105 routinely accelerates or brakes, how user 105 routinely makes turns, e.g., wide turns or narrow turns, turn speed, and the like, user 105's speed vs. speed limit, e.g., 10 miles above speed limit, and the like, may be used to calculate confidence score and to authenticate user 105.

In an embodiment, the system may consider traffic flows or traffic incidents in the analysis. For example, user 105's travel may be affected by recent road constructions or other traffic incidents, which may cause delay or traffic detour that may deviate user 105 from user 105's routines. The system may check traffic flow or traffic incidents during the past 8 hours to take these additional factors into consideration. As such, the system may consider extraordinary factors that may cause use 105 to deviate from user 105's routines. Further, the system may consider user 105's calendar for events or appointments that may cause user 105 to deviate from user 105's routines. For example, user 105 may have a doctor's appointment that may cause user 105 to deviate from user 105's routines. These additional factors may be considered for calculating the confidence score.

In one embodiment, if a user's calendar shows various appointments and events that are not typical for the user during that day, the day before, or days before, the system may disregard these “one-time” movements and locations. For example, if a payment request is received Saturday afternoon, but the user's calendar shows several events that are not typical, the system may disregard the user's movements on Saturday and start with user movements on Friday. In another embodiment, instead of disregarding the “one-time” movements and locations, the system may analyze the user's movements based on calendar events. For example, the system may disregard the user's typical pattern on Saturday and instead compare the user's actual movements and locations with what is expected from the user's calendar. Typical routines from Friday and earlier, if desired, may then be analyzed in conjunction with the Saturday movements.

In an embodiment, the confidence score may be negatively affected if the recent location history includes locations or routes not taken by user 105 before, as this may be an indication that user device 110 was not carried by user 105. Nevertheless, the confidence score may not be negatively affected if user 105's calendar or other external factors, such as traffic incidents, that may offer reasons for the deviation from user 105's routines.

In an embodiment, more recent location history may weigh more in the calculation of confidence score than less recent location history. For example, locations or routes visited or taken by user 105 in the last hour may weigh more in calculating the confidence score than locations or routes visited or taken by user 8 hours ago. As such, locations or routes more recently visited or taken by user 105 that match user 105's routines may increase the confidence score more than locations or routes less recently visited or taken by user 105 that match user 105's routines. Further, locations or routes more recently visited or taken by user that deviates from user 105's routines may decrease the confidence score more than locations or routes less recently visited or taken by user 105 that deviate from user 105's routines.

In an embodiment, the comparison between user 105's recent location history and user 105's routine may include consideration for different seasons, different days of the week, months, holiday schedules, and the like. For example, user 105 may have different routine routes from home to work between the summer season and the winter season. As such, the system may consider which routine route to use based on the season. In another example, user 105 may visit different routine locations on week days and on weekends.

At step 308, the confidence score may be used to authenticate user 105. In particular, the system may determine whether user device 110 still is carried by user 105 based on the confidence score, which may indicate how closely user device 110's recent location history matches user 105 routines. The user authentication may be implemented for various transactions or processes. For example, user authentication may be used for device access, e.g., unlocking user device 110, online payments, online financial transactions, access to social network accounts, access to online financial accounts, access to email accounts, access to public or private networks, access to other online accounts, access to private or personal information stored in user device 110, and the like.

The confidence score may be used to authenticate user 105 or to determine a level security input required from user 105. For example, a high confidence score may allow user 105 to be authenticated without further input from user 105. On the other hand, a lower confidence score may require user 105 to input additional passwords or answer additional security questions for authentication.

In an embodiment, the confidence score may be used to determine the transaction fee for a payment transaction. In particular, for a transaction using a credit card, the transaction fee for a “card-not-present” transaction may be reduced based on the confidence score. In an embodiment, the transaction fee may be reduced to be the same as for a “card-present” transaction. In another embodiment, the transaction fee may be reduced to be less than a “card-not-present” transaction, but more than a “card-present” transaction. In still another embodiment, the transaction fee may be minimized when user 105 is authenticated by location history in a “card-present” transaction. Further, transaction fees for other transactions, such as bank fee for other online fund transactions, may also be determine based on the confidence score. The transaction fee may be determined by the payment service provider. In another embodiment, the payment service provider may send the confidence score to the operator of the funding source, such as the issuing bank of a credit card, and the transaction fee may be determined by the operator of the funding source based on the confidence score.

In an embodiment, user device 110's pin lock frequency may change based on the confidence score. For example, a higher confidence score may allow user device 110 to stay unlocked longer, e.g., 10 minutes. A lower confidence score may require user device 110 to lock up faster when inactive, e.g., 2 minutes. Thus, user 105 may need to enter pin code to unlock and access user device 110 more frequently when the confidence score is low. For example, when user 105 is at a new location or is taking a new route different from user 105's routines, user 105 may be required to input additional passwords or answer additional security questions to unlock user device 110.

In an embodiment, user 105's location history may be used to verify transactions made by via user device 110. In particular, user 105's location history may be used to verify purchases or payments made via user device 110. For example, if user 105 disputes a transaction that was made at a particular merchant via user 105's payment account, user 105's location history may be used to determine whether the particular merchant is near or along user 105's routine locations or routes. A probability whether the disputed transaction was made by user 105 or by another person may be calculated based on user 105's routines. If the disputed transaction was made at a routine location of user 105 or a merchant where user 105 frequently visited, then the probability is greater that user 105 made the disputed transaction. If the disputed transaction was made at a location where user 105 had never visited or had rarely visited, the probably is lower that user 105 made the disputed transactions. Thus, user 105's routines may be used to verify transactions made by user 105.

In an embodiment, user 105's routines may be used to predict transportation needs. In particular, user 105's travel routines may be used to predict when and where user 105 may need certain transportations. For example, user 105 may have a routine of traveling from an airport to a work place every Friday afternoon when user 105 returns home from user 105's weekly business trips. The system may predict that user 105 may need a taxi or a shuttle to transport user 105 from the airport to the work place every Friday afternoon. Thus, advertisements may be generated to entice user 105 to utilize certain transportation services. In another embodiment, user 105 may install a taxi app on user device 110 which may automatically order a taxi or a shuttle for user 105 on Friday afternoons.

In an embodiment, routines from various users may be analyzed to predict local traffics or needs for transportation resources. For example, the system may predict that a crowd of users may desire to travel away from a sports stadium every Sunday night after a game at the sports stadium ends. Thus, the system may predict that transportation resources, such as additional taxis or buses, may be needed to facilitate crowd transportation on Sunday nights at the sports stadium. In another embodiment, routines from various users may be used to coordinate car sharing or car pools among different users. For example, user 105 may install an application on user device 110 to implement car sharing or car pools. The system may match user 105's travel routines with other user with similar travel routines and may suggest that user 105 share car or car pool with other users that have similar routine routes.

By using the above process 300, a user's recent location history may be used to authenticate the user. In particular, the user's recent location history may be compared with the user's routines to determine a confidence score indicating whether how closely the user's recent location history matches the user's routines. The confidence score may be used to authenticate the user according to security requirements of various types of transactions. In one embodiment, the confidence score may be used to determine a transaction fee for using a certain funding source, such as a credit card, to make a payment. Further, the user's routines may be used to verify transactions made via the user's mobile devices. In other embodiments, the user's routines may be used to implement car sharing or car pools, or to predict needs for various transportation resources by different users.

In the above processes, the steps are executed at payment provider server 170. In one embodiment, the steps may be executed at user device 110 or merchant server 140. In still another embodiment, the steps may be executed among payment provider server 170, user device 110, and merchant server 130 in coordination with each other.

The following are exemplary scenarios in which the above processes may be implemented.

### Example 1

A user of a payment account at a payment service provider. The user designates various funding sources, such as credit cards, bank accounts, and the like to make payments via the payment account. The user installs a payment application from the payment service provider at the user's mobile device to facilitate payments. The user typically uses the payment application on the mobile device to make payments electronically at various merchants. In particular, the user allows the payment application to monitor and collect the user's location and to authenticate the user using the user's location history.

The payment service provider collects location information and location history of the user from the user's mobile device and identifies the user's routines based on the location history of the user. The payment service provider determines that user's routine locations include home, work place, a grocery store, a shopping mall, a gas station, a school, and the like. In particular, the payment service provider determines that the user typically travels from home to work on week day mornings and returns from work to home on week day afternoons. The user also routinely shops at the grocery store on Tuesday nights and get gas at the gas station on Thursday nights. The user also visits the school on Monday and Wednesday nights for classes. On the weekends, the user shops at the shopping mall on Saturdays once or twice a month, e.g. 25%-50% probability at the shopping mall on Saturday afternoons.

On a Wednesday night, the user is shopping at the shopping mall. The user is making a purchase and the user is using the payment application on the mobile device to pay for the purchase. In particular, the user chooses a credit card to fund the purchase. During user authentication, the payment service provider compares the user's recent location history with the user's routines. The payment service provider detects that the user is at the shopping mall on Wednesday night. The payment service provider also notes that, although the user is at the shopping mall which is a routine location for the user, the user's routine on Wednesday night should be at the school. The payment service provider also notes on the user's calendar and notes that the user is on Spring break during which the user does not have classes at the school on Wednesday night. Thus, the payment service provider finds a reason for the user's deviation from the user's routine.

The payment service provider also notes that, before going to the shopping mall, the user was home, which is another routine location of the user. The payment service provider also compares the particular route the user took from home to the shopping mall with the user's routine route from home to the shopping mall. The user took the same route by the same mode of transportation, by car. Further, the payment service provider also notes that the manner of driving, such as speed, acceleration, braking, coming, and the like also matches the user's typical routines.

The payment service provider calculates a confidence score based on the above factors. The payment service provider sends the confidence score to the operator of the credit card. Because many aspects of the recent location history of the user's mobile device matches that of the user's routines, the confidence score may be relatively high to indicate that the user is most likely carrying the mobile device through which the payment is to be made. Thus, the credit card operator may reduce the transaction fee for this “card-not-present” transaction. Accordingly, the user is authenticated and the payment is processed for the user's purchase. Further, the user is able to receive a reduced transaction fee via authentication based on location history.

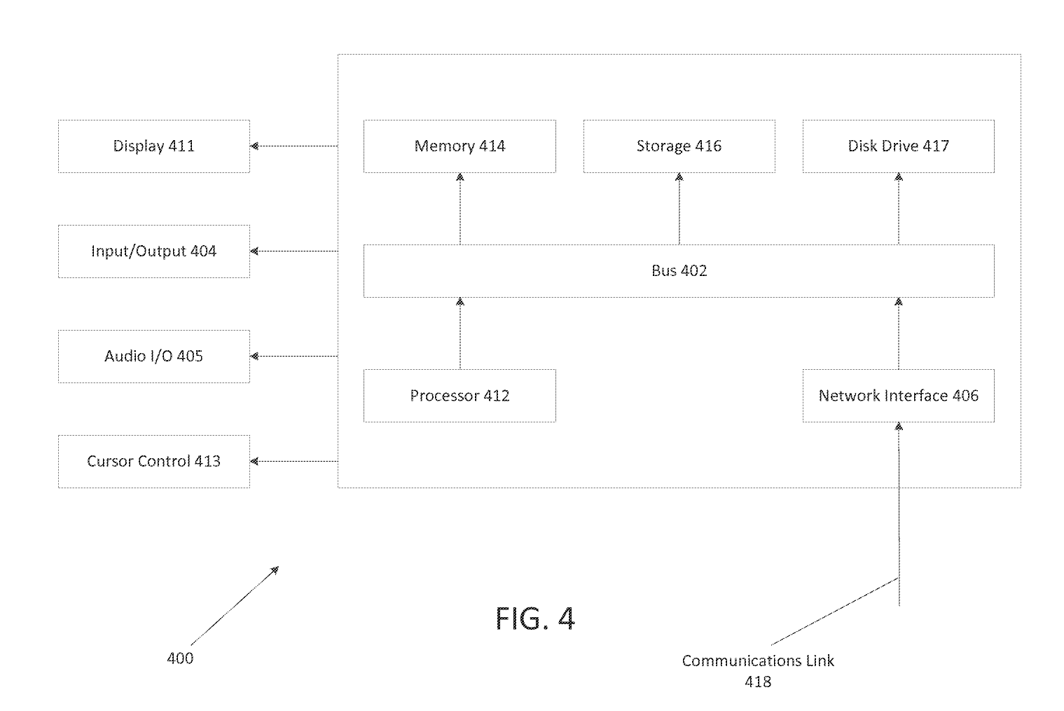

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, wearable device, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing a payment account of a user and location history of the user; and
one or more processors in communication with the memory and adapted to:
receive an authentication request from the user;
perform a comparison analysis between recent location history of a user device and routines of the user;
authenticate the user based on the comparison analysis.

2. The system of claim 1, wherein the routines of the user comprise routine locations repeatedly visited by the user and routine routes repeatedly taken by the user.

3. The system of claim 2, wherein the comparison analysis comprises calculating a confidence score based on an amount of matching locations and routes between the recent location history of the user device and the routines of the user.

4. The system of claim 2, wherein the comparison analysis compares a manner of travel between the recent location history of the user device and the routines of the user including one or more of a travel speed, a manner of acceleration, a manner of deceleration, and a manner of turning.

5. The system of claim 3, wherein the one or more processors are further adapted to determine a transaction fee for using a credit card account in a payment transaction based on the confidence score.

6. The system of claim 5, wherein the transaction fee is less than a standard “card-not-present” fee when the confidence score is greater than a predetermined value.

7. The system of claim 3, wherein the one or more processors are further adapted to determine a log out frequency of the user device based on the confidence score.

8. The system of claim 3, wherein the one or more processors are further adapted to request additional security input from the user when the confidence score is less than a predetermined value.

9. The system of claim 1, wherein the recent location history of the user device comprises locations and routes of the user device during a particular period before the authentication request.

10. The system of claim 1, wherein a length of the particular period is determined based on a security requirement of the user authentication.

11. The system of claim 1, wherein the recent location history of the user device comprises locations and routes of the user device since a last user authentication.

12. A method comprising:
receiving, by hardware processor of a payment service provider, an authentication request from a user of a payment account registered at the payment service provider;
performing, by the hardware processor, a comparison analysis between recent location history of a user device and routines of the user;
authenticating, by the hardware processor, the user based on the comparison analysis.

13. The method of claim 12, wherein the comparison analysis comprises:
comparing routine locations and routine routes of the user with the recent location history of the user device; and
determining a confidence score based on an amount of locations and routes in the recent location history of the user device that match the routine locations and the routine routes of the user.

14. The method of claim 13, wherein the confidence score is increased when the amount of matching locations and routes increases.

15. The method of claim 13, wherein the confidence score is decreased when the recent location history of the user device includes a new location or a new route that has not been visited or taken by the user.

16. The method of claim 15 further comprising:
obtaining reports of a traffic incident occurred along routine route of the user;
determining whether the new location or the new route is associated with a detour caused by the traffic incident; and
reverse the decrease of the confidence score when the new location or the new route is associated with the detour.

17. The method of claim 15 further comprising:
analyzing a calendar of the user;
determining whether the calendar of the user includes an appointment associated with the new location or the new route; and
reverse the decrease of the confidence score when the new location or the new route is associated with the appointment.

18. A non-transitory computer-readable medium comprising instructions which, in response to execution by a computer system, cause the computer system to perform a method comprising:
collecting a location history of a user detected at a mobile device of the user;
determining routines of the user based on the location history of the user;
authenticating the user at the mobile device based on a comparison between a recent location history of the user and the routines of the user.

19. The non-transitory computer-readable medium of claim 18, wherein the method further comprises verifying a transaction made via the mobile device by comparing a location of the transaction with the routines of the user.

20. The non-transitory computer-readable medium of claim 18, wherein the method further comprises predicting the user's need for a transportation resource based on the routines of the user.
